(19) United States
(12) Patent Application Publication
(10) Pub. No.: US 2005/0183752 A1
(43) Pub. Date: Aug. 25, 2005

(54) Mobile vehicle steam cleaning system

(76) Inventor: Emmanuel Hosea Williams, Detroit, MI (US)

Correspondence Address: Emmanuel H. Williams, 625 E. Grand Blvd., Detroit, MI, 48207, US

(21) Appl. No.: 10/811,686

(22) Filed: Mar. 29, 2004

Related U.S. Application Data
(60) Provisional application No. 60/459,817, filed on Apr. 3, 2003.

(51) Int. Cl. B08B 3/00

(52) U.S. Cl. 134/34; 134/123

(57) ABSTRACT

This invention relates to an apparatus and method of usage of the apparatus where the apparatus is a mobile self-contained system for washing motor vehicles, specifically using a vapor cleaning system and the power of vapor and condensation to clean vehicles. The apparatus is completely self-sufficient, easily transported, has the ability to clean vehicles efficiently, with minimal support and in an environmentally efficient manner.

### BACKGROUND OF THE INVENTION

1. Field of the Invention

This invention relates to an apparatus and method of usage of the apparatus where the apparatus is a mobile self-contained system for washing motor vehicles, specifically using a vapor cleaning system and the power of vapor and condensation to clean vehicles. The apparatus is completely self-sufficient, easily transported, and has the ability to clean vehicles efficiently, with minimal support and in an environmentally efficient manner

2. Description of Prior Art

Many car and truck owners enjoy individualizing their vehicles by purchasing specialty paint jobs, stylish wheels, and chrome accessories. Others prefer to maintain their cars, trucks, sports utility vehicles, and so on . . . , as close to factory issue as possible. Many rely on routine cleaning and maintenance to maximize their enjoyment, as well as the life of their car and specialty accessories.

Several industries including dealers, fleet operators, automatic, stationary and mobile car washing units currently share the requirement for a costly and time inefficient way of cleaning vehicles. All methods of washing vehicles, by law, must be environmentally safe. It is illegal for chemical, wax, and water from stationary or portable car washes to use the sewage system. However, current methods contaminate the sewage system and pollute the environment. Current operators must employ special systems and techniques in order not to pollute the environment.

Car washers should know that many of these methods are contrary to the laws and regulations set by the Environment Protection Agency (EPA). In extreme cases, the EPA can enforce these laws and shut down or fine these business owners.

Devices have been introduced to enable various mobile cleaning applications. The main disadvantage of these types of devices is that they must be connected to an external water source to work, which limits its true mobile usability and availability, or require the transport of large volumes of water, or they utilize harsh chemical in the process.

Automatic car wash facilities have become increasingly available, with many directly associated with fueling station. These fueling stations must be equipped with traps to collect the dust, dirt and chemicals that come from the automobile. These traps must be cleaned periodically and a licensed, qualified hauler must dispose of the water.

These automated facilities have become increasingly convenient, however, they are unable to offer the detailed cleaning required to maximize the life of they vehicle and specialized finishes. These facilities are also stationary or require transport by large trailers. Also, for large fleets of vehicles both the use of a commercial washing facility or buildings dedicated washing facilities require extensive resources and are very expensive.

It is seen from the forgoing that there is a need for an apparatus and method of usage which overcomes the disadvantages in the prior art of vehicle washing systems, specifically supplying a mobile self-contained system, specifically using the power of vapor and condensation to clean vehicles that is completely self-sufficient, easily transported, has the ability to clean vehicles efficiently, with minimal support and in an environmentally safe manner.

### BRIEF SUMMARY OF INVENTION

It is therefore an object of this invention to provide a mobile, self-contained vehicle washing system which permits rapid cleaning of vehicles;

It is therefore a further object to provide a mobile, self-contained vehicle washing system which permits rapid cleaning of vehicles at low operating costs;

It is therefore a still further object to provide a mobile, self-contained vehicle washing system to maintain vehicles as close to factory issue as possible;

It is therefore a still further object to provide a mobile, self-contained vehicle washing system to allow low resource detailing;

It is therefore a still further object to provide a mobile, self-contained vehicle washing system which through vaporization and condensations removes impurities from the water;

It is therefore a still further object to provide a mobile, self-contained vehicle washing system whose cleaning head is designed to protect a vehicle's surface and finish;

It is therefore a still further object to provide a mobile, self-contained vehicle washing system which provides virtually spotless drying;

It is therefore a still further object to provide a mobile, self-contained vehicle washing system which is easily transported;

It is therefore a still further object to provide a mobile, self-contained vehicle washing system, which eliminates intensive operations, including long distance transport of the vehicles;

It is therefore a still further object to provide a mobile, self-contained vehicle washing system which eliminates long distance transport of large amounts of water;

It is therefore a still further object to provide a mobile, self-contained vehicle washing system which eliminates the necessity of connecting to an external water source;

It is therefore a still further object to provide a mobile self-contained vehicle washing system, which provides constant condensation, heated vapor without regular refills or constant dependence on a water source;

It is therefore a still further object to provide a mobile, self-contained vehicle washing system which eliminates the use of chemicals to detail a vehicle;

It is therefore a still further object to provide a mobile, self-contained vehicle washing system which eliminates the need for or manual application of soap and wax;

It is therefore a still further object to provide a mobile, self-contained vehicle washing system, which does not need a sewage system for drainage;

It is therefore a still further object to provide a mobile, self-contained vehicle washing system which eliminates runoff;

It is therefore a still further object to provide a mobile, self-contained vehicle washing system which, because the condensation is used to clean the vehicle, creates no water, ground, or air pollution;

It is therefore a still further object it is a further object of this invention to provide a mobile, self-contained vehicle washing system, which is environmentally safe.

### BRIEF DESCRIPTION OF DRAWINGS

FIG. 1 is a detailed view of the steamer reservoir and its attachments. This steamer reservoir is cast iron and holds one gallon of water. It has a heater coil which, when energized with AC current heats up and converts the water to vapor;

FIG. 2 is a detailed view of the head attachment, including discharge hose, brushes head, head sprayer, and sponge;

FIG. 3 is a detailed view of the brush head cover, consisting of a soft cloth, used to cover the attachment and prevent the bristles from scratching the vehicle surface and aids in the conversion of steam to condensation;

FIG. 4 is a brief description of a heating element used to heat water in the steamer reservoir and convert water into steam.

FIG. 5 is a brief description of the inside of the steam reservoir and the position of the heating element.

FIG. 6 is a brief description of a generator used to provide the power source for equipment.

FIG. 7 is a brief description of the side and back view of the four-wheel cart used to transport equipment.

### DETAILED DESCRIPTION AND OPERATION OF INVENTION

Although variations can be envisioned for implementing this mobile system for washing vehicles, the following method for assembling and using the power of vapor and condensation to clean and detail vehicles has been tested and is recommended:

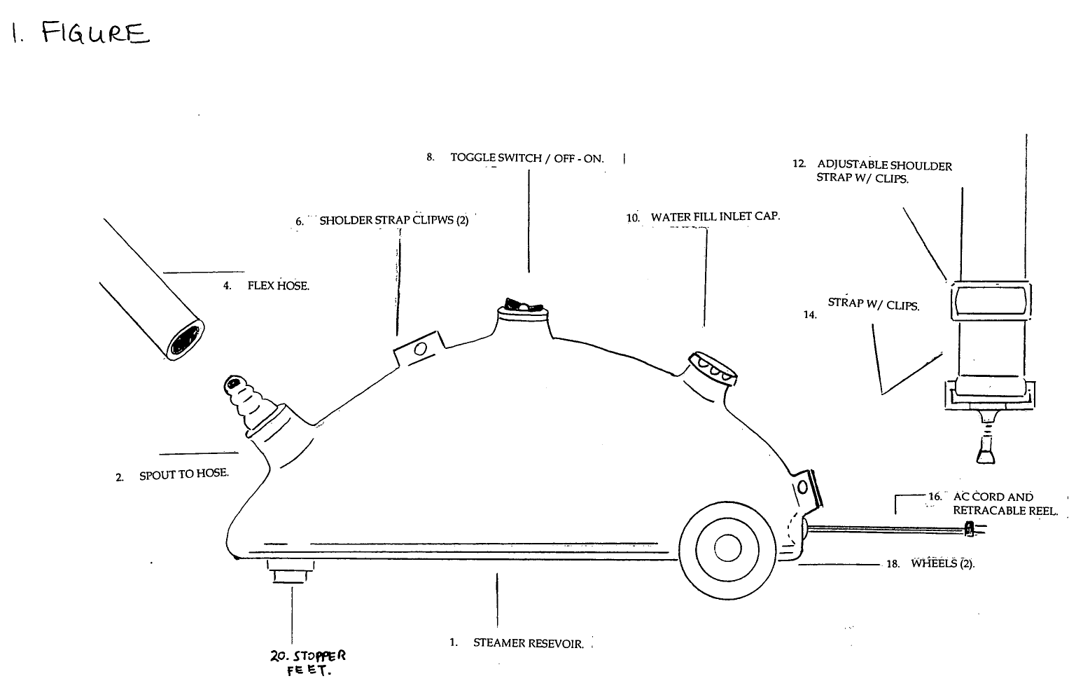

Referring now to the drawings wherein like numerals refer to like elements throughout the several views, one sees that FIG. 1 is a detailed view of the steamer reservoir and its attachments. This steamer reservoir is cast iron and holds one gallon of water. It has a heater coil inside that energizes when heated up and converts water into vapor.

FIG. 1 attachment 2, the spout to hose. This spout connects the discharge stream flex hose to the steam reservoir.

FIG. 1 attachment 4, the discharge hose carries the steam from the steamer reservoir to the sprayer and brush head.

FIG. 1 attachment 6, the shoulder strap clip. The purpose of this attachment is to connect the belt holder to the steamer reservoir.

FIG. 1 attachment 8, the on/off switch. This switch turns the steamer on or off.

FIG. 1 attachment 10, the water fill inlet and cap. This cap opens and closes the water inlet to the steamer reservoir.

FIG. 1 attachment 12, the adjustable shoulder strap. This is used to adjust the length of the shoulder strap.

FIG. 1 attachment 14, the shoulder strap. This strap is used to carry steamer around the shoulder for portability.

FIG. 1 attachment 16, the AC power cord. This cord transports AC current to the heating coil.

FIG. 1 attachment 18, the wheels. The wheels support the steamer reservoir when pulled on the ground.

FIG. 1 attachment 20, the stopper feet supports the frond end of the steamer reservoir.

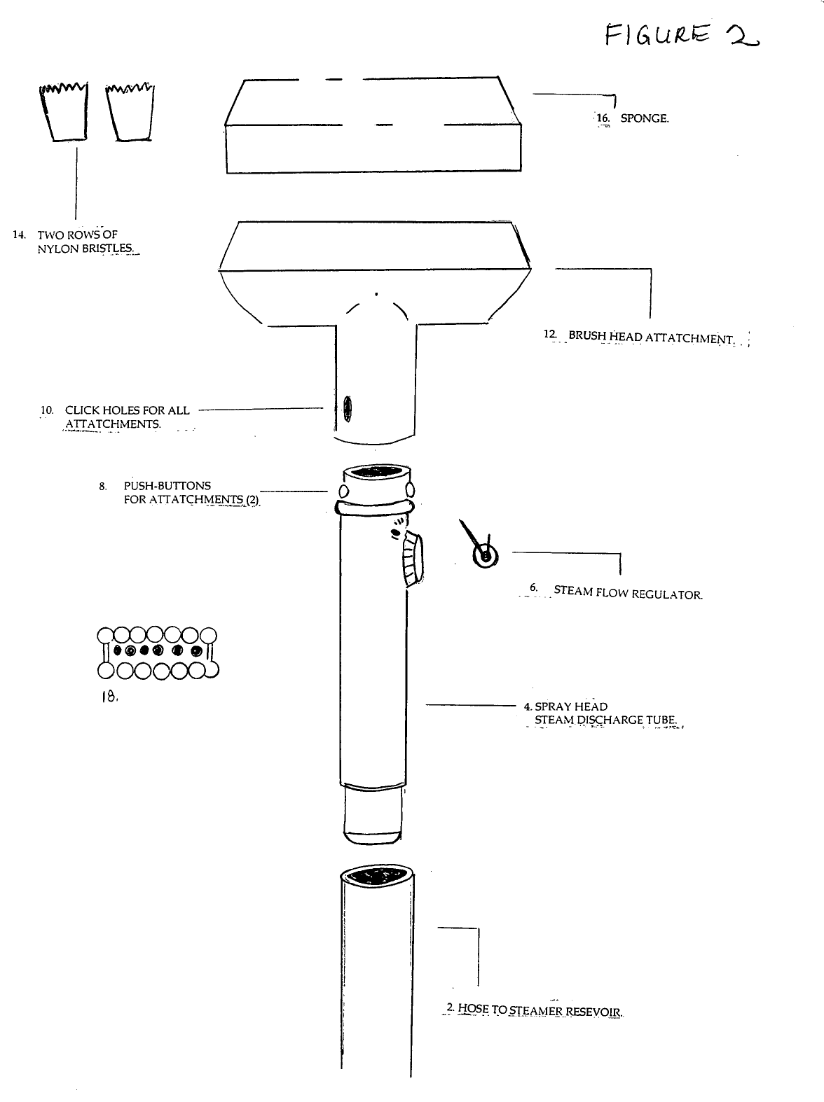

FIG. 2 is a detailed view of the brush head, sprayer head, sponge and discharge hose.

FIG. 2 attachment 2 is the discharge hose from the steamer reservoir.

FIG. 2 attachment 4 is the steam discharge tube spray head. This spray head discharge steam from tube in a mist.

FIG. 2 attachment 6 is the steam flow regulator. This regulates the flow of steam from the spray head.

FIG. 2 attachment 8 is the connection lock. This lock connects the spray head to the brush head.

FIG. 2 attachment 10, the click hole helps to connect the brush head to the spray head.

FIG. 2 attachment 12 is the brush head. This brush head is used to wash down the vehicles.

FIG. 2 attachment 14 is a brush bristle. The brush bristle is used to assist in cleaning vehicles.

FIG. 2 attachment 16 is a sponge. This sponge prevents steam from coming into direct contact with the vehicle and assists to convert steam into condensate.

FIG. 2 attachment 18 is a steam port which allows steam to exit through the port for cleaning.

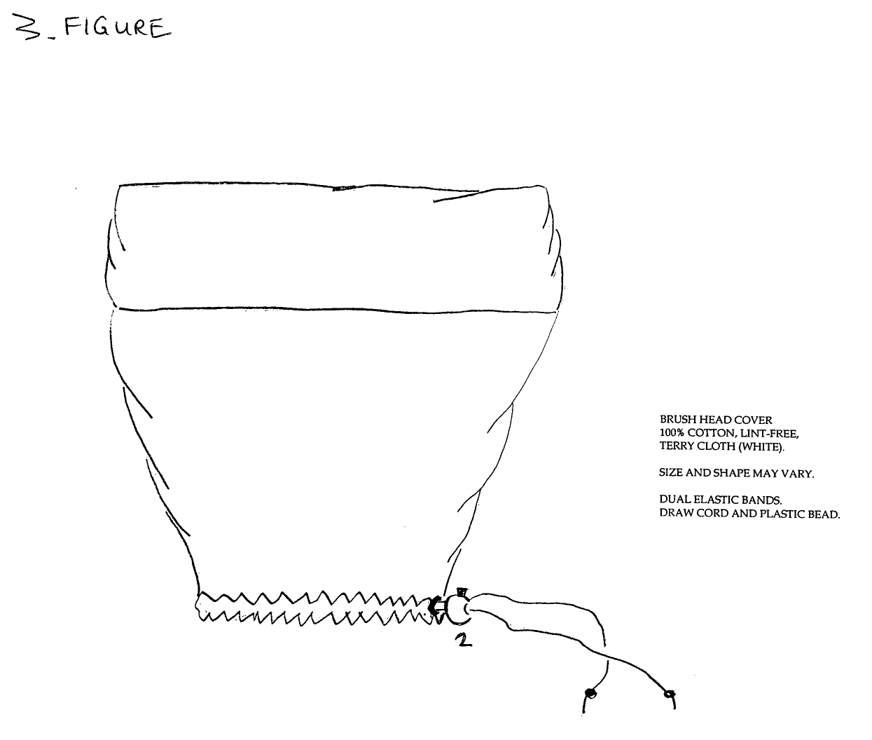

FIG. 3 is a detailed view of the brush head cover used to cover the brush head to prevent the bristle from scratching the surface of the vehicle. Also, assist in converting the steam into condensate.

FIG. 3 attachment 2 is a draw cord. The cord tightens around the neck of the brush head to prevent the cover from coming off the brush head.

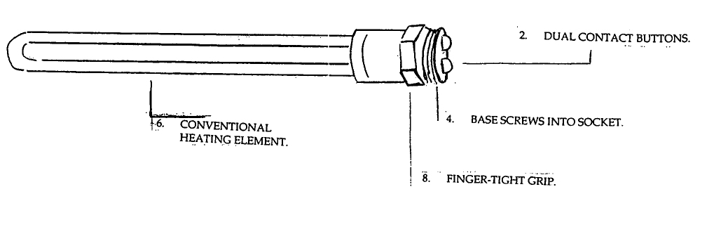

FIG. 4 is a detailed view of a heating element used to heat water in the steamer reservoir and convert the water into steam.

FIG. 4 attachment 2 is electric connection for energizing the heating element from the power source.

FIG. 4 attachment 4 is the base screw threads from installing the heating element into the steamer reservoir and to prevent any steam leaks.

FIG. 4 attachment 6 is the heating element rod. This rod heats up and converts the water into steam.

FIG. 4 attachment 8 is the finger tight grip, which helps to tighten the heating element to the steamer reservoir.

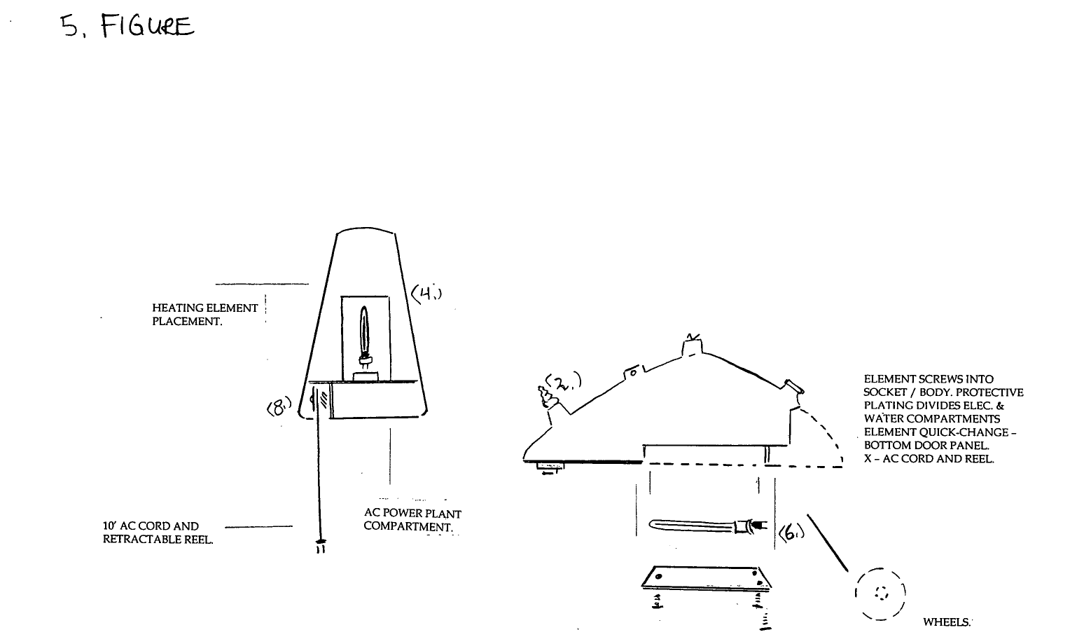

FIG. 5 is a detailed view of the inside of the heating element, which is inside of the steam reservoir.

FIG. 5 attachment 2 is the area where the steam discharges from the steamer reservoir.

FIG. 5 attachment 4 is the position of the heating element which is inside of the steamer reservoir.

FIG. 5 attachment 6 is a side view of the heating element which is inside of the steamer reservoir.

FIG. 5 attachment 8 is the Alternating Current (AC) cord retractor reel.

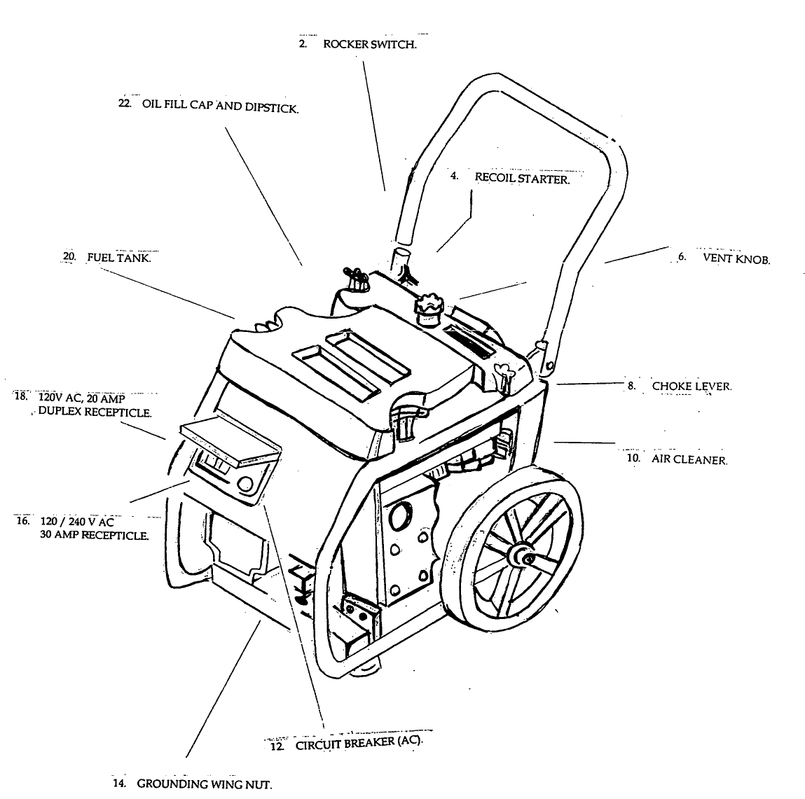

FIG. 6 is a detailed view of the generator.

FIG. 6 attachment 2 is the rocker switch used to adjust the generator handle.

FIG. 6 attachment 4 is the recoil starter used to start the generator.

FIG. 6 attachment 6 is the vent knob used to vent the gas tank.

FIG. 6 attachment 8 is the choke lever used to start the generator when cold.

FIG. 6 attachment 10 is the air cleaner used to clean the air going into the generator's motor.

FIG. 6 attachment 12 is the AC circuit breaker used to protect the generator from overload.

FIG. 6 attachment 14 is the grounding wind nut used to properly ground the generator.

FIG. 6 attachment 16 is the 120/240 volts AC receptacle used to provide current to appliance.

FIG. 6 attachment 18 is the 120 volts AC receptacle used to provide current to appliance.

FIG. 6 attachment 20 is the gas tank.

FIG. 6 attachment 22 is the oil fill cap and dipstick used to check oil and/or fill generator with oil.

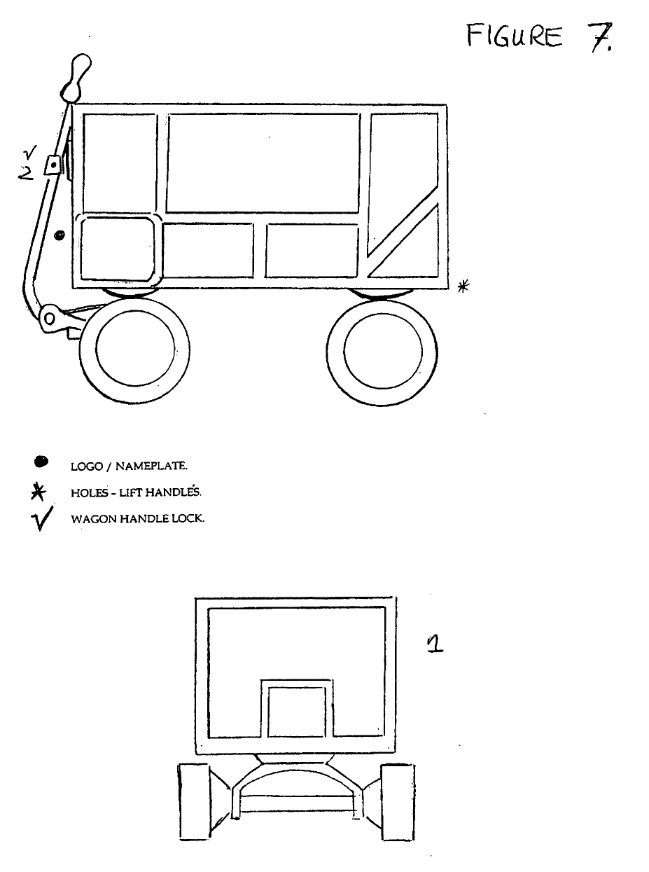

FIG. 7 is a detailed view of the side and back view of a four wheel cart.

FIG. 7 attachment 2 is the handle used to pull and steer the cart.

FIG. 7 attachment 4 is the outside housing cage used to hold items in the cart.

FIG. 7 attachment 6 is the wheel, used to move that cart more easily.

### SUMMARY

Thus by the present invention its objects and advantages are realized and although preferred embodiments have been disclosed and describe in detail herein, its scope should be determined by that of the appended claims. This revolutionary concept for a mobile self-contained vehicle cleaning system clearly provides an innovative and valuable method for cleaning and detailing vehicle. This method is particularly useful in, although not strictly limited to, automobile detailing operations desiring portability of equipment and materials for mobile washing and cleaning services. While this method was initially conceived for use in the mobile vehicle washing and detailing industry, it can equally be conformed and used to great benefit in the overall car wash industry.

1. A method of usage to provide a mobile, self-contained vehicle washing system which permits rapid cleaning of vehicles; at low operating costs; to allow low resource detailing; removing impurities from the water through vaporization and condensation; is designed to protect a vehicle's surface and finish and maintains a clean surface for a longer period of time; which is easily transported; does not need a constant external water source because of the expansion of water×1600 when converted to steam; does not use chemicals to detail a vehicle; nor create environmentally hazardous runoff.

2. The method of claim 1, includes heated vapor and condensation to clean a vehicle.

3. The method of claim 1, includes utilizing a light-weight vapor producing machine which converts water into hours of steam cleaning

4. The method of claim 3, includes using a machine with a reservoir of water, a heating coil that is energized by a power source, an on/off switch, connecting hose and head attachments, and a belt, wheels, or cart for transporting the apparatus to clean a vehicle.

5. The method of claim 1, also includes inserting a sponge into a head attachment to convert the vapor into heated condensation which is used to clean the vehicle.

6. The method of claim 5, prevents the vapor from coming into direct contact with the vehicle surface, forming a protective barrier between the heated vapor and a vehicle's finish.

7. The method of claim 1, also includes the process of spraying a vehicle with steam and wiping it with a cloth to remove dirt and impurities, eliminating environmentally hazardous runoff.

8. The method of claim 1, also includes a more effective and longer lasting approach to cleaning due to the absence of chemicals, soap and detergents residue which allow dust to collect faster on a vehicle's surface.

9. The method of claim 1, comprising using the production of condensation and method in claims 1 through 8 to break down dirt and other impurities rendering it easy to remove from a vehicle's surface.

10. The method of claim 1 through 9, comprising a complete cleaning system, which is mobile, resource efficient, economic, uses no chemicals or additives, creates no runoff, and is environmentally safe and easy to transport.
